(19) United States
(12) Patent Application Publication
(10) Pub. No.: US 2025/0379348 A1
(43) Pub. Date: Dec. 11, 2025

(54) FILTER

(71) Applicant: Murata Manufacturing Co., Ltd., Nagaokakyo-shi (JP)

(72) Inventor: Masayuki KIKUDA, Nagaokakyo-shi (JP)

(21) Appl. No.: 19/300,813

(22) Filed: Aug. 15, 2025

Related U.S. Application Data
(63) Continuation of application No. PCT/JP2024/008453, filed on Mar. 6, 2024.

(30) Foreign Application Priority Data
Mar. 30, 2023 (JP) 2023-055567

(51) Int. Cl. H01P 1/205; H01P 1/208

(52) U.S. Cl. CPC H01P 1/2056; H01P 1/208

(57) ABSTRACT

A filter includes first and second via electrodes, first and second shielding conductors, and first, second, third and fourth planar electrodes. The first shielding conductor is on a dielectric substrate and adjacent to an end of the first and second via electrodes. The second shielding conductor is on the dielectric substrate and adjacent to another end of the first and second via electrodes. The first planar electrode is connected to the end of the first via electrode. The second planar electrode is connected to the other end of the first via electrode. The third planar electrode is connected to the end of the second via electrode. The fourth planar electrode is connected to the other end of the second via electrode. The first and third planar electrodes are capacitively coupled to the first shielding conductor. The second and fourth planar electrodes define a common electrode.

### CROSS REFERENCE TO RELATED APPLICATIONS

This application claims the benefit of priority to Japanese Patent Application No. 2023-055567 filed on Mar. 30, 2023 and is a Continuation Application of PCT Application No. PCT/JP2024/008453 filed on Mar. 6, 2024. The entire contents of each application are hereby incorporated herein by reference.

### BACKGROUND OF THE INVENTION

### 1. Field of the Invention

The present disclosure relates to filter technologies including resonators.

### 2. Description of the Related Art

For example, International Publication No. 2018/100923 describes the structure of a filter using a resonator. International Publication No. 2018/100923 discloses a filter in which capacitor-forming conductor patterns on a dielectric layer are connected by inductor-forming via conductor patterns to capacitor-forming conductor patterns on another dielectric layer.

However, the filter in International Publication No. 2018/100923 may have increased manufacturing variations in filter characteristics (resonant with increases in the frequency) frequency at which the filter is used. This is because, in transverse electric (TE) mode, the resonant frequency of the filter is determined by the outer volume of a dielectric substrate. In particular, changes in the diameter of the inductor-forming via conductor patterns (via electrodes) may cause the resonant frequency to change significantly.

### SUMMARY OF THE INVENTION

Example embodiments of the present invention provide filters each with reduced changes in resonant frequency resulting from changes in diameter of via electrodes due to manufacturing variations.

A filter according to an example embodiment of the present invention includes a first via electrode, a second via electrode, a first shielding conductor, a second shielding conductor, a first planar electrode, a second planar electrode, a third planar electrode, and a fourth planar electrode. The first via electrode and the second via electrode are provided in a dielectric substrate. The first shielding conductor is provided at the dielectric substrate, and positioned at or adjacent to one end of the first via electrode and one end of the second via electrode. The second shielding conductor is provided on the dielectric substrate, and positioned at or adjacent to one other end of the first via electrode and one other end of the second via electrode. The first planar electrode is provided in the dielectric substrate, and connected to the one end of the first via electrode. The second planar electrode is provided in the dielectric substrate, and connected to the other end of the first via electrode. The third planar electrode is provided in the dielectric substrate, and connected to the one end of the second via electrode. The fourth planar electrode is provided in the dielectric substrate, and connected to the other end of the second via electrode. The first planar electrode and the third planar electrode are each capacitively coupled to the first shielding conductor individually. The second planar electrode and the fourth planar electrode are electrically connected and define a common electrode.

In each of filters according to example embodiments of the present invention, the second planar electrode and the fourth planar electrode are electrically connected and define a common electrode. This configuration reduces changes in resonant frequency of the filters resulting from changes in diameter of the via electrodes due to manufacturing variations.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 schematically illustrates a filter according to Example Embodiment 1 of the present invention.

FIG. 2 is a graph illustrating the insertion loss of the filter according to Example Embodiment 1 of the present invention.

FIG. 3 schematically illustrates a filter according to a comparative example.

FIG. 4 is a graph illustrating the insertion loss of the filter according to the comparative example.

FIGS. 5A to 5C illustrate transverse electric (TE) mode resonance and transverse electromagnetic (TEM) mode resonance in the filter according to the comparative example.

FIGS. 6A to 6C illustrate transverse electric (TE) mode resonance and transverse electromagnetic (TEM) mode resonance in the filter according to Example Embodiment 1 of the present invention.

FIGS. 7A and 7B illustrate the relationships between the resonant frequency in transverse electric (TE) mode and the resonant frequency in transverse electromagnetic (TEM) mode.

FIG. 8 schematically illustrates a filter according to Modification 1 of an example embodiment of the present invention.

FIG. 9 is a graph illustrating the insertion loss and return loss of the filter according to Modification 1 of an example embodiment of the present invention.

FIG. 10 is a graph illustrating the insertion loss of the filter according to Modification 1 of an example embodiment of the present invention, with varying via electrode diameter.

FIG. 11 schematically illustrates a filter according to Modification 2 of an example embodiment of the present invention.

FIG. 12 is a graph illustrating the insertion loss and return loss of the filter according to Modification 2 of an example embodiment of the present invention.

FIG. 13 schematically illustrates a filter according to Example Embodiment 2 of the present invention.

FIG. 14 is a graph illustrating the insertion loss and return loss of the filter according to Example Embodiment 2 of the present invention.

FIG. 15 is a graph illustrating the insertion loss of the filter according to Example Embodiment 2 of the present invention, with varying via electrode diameter.

FIG. 16 schematically illustrates a filter according to Example Embodiment 3 of the present invention.

FIG. 17 is a graph illustrating the insertion loss and return loss of the filter according to Example Embodiment 3 of the present invention.

### DETAILED DESCRIPTION OF THE EXAMPLE EMBODIMENTS

Example embodiments of the present invention will be described in detail below with reference to the drawings. In the drawings, the same or corresponding features will be designated by the same reference signs, and descriptions of such features will not be repeated.

### Example Embodiment 1

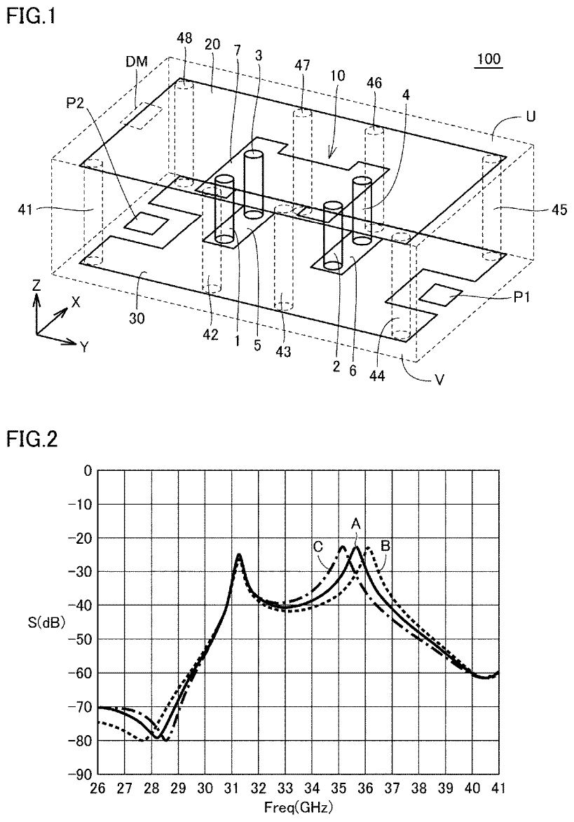

FIG. 1 schematically illustrates a filter 100 according to Example Embodiment 1 of the present invention. The filter 100 includes a resonator 10, and input/output terminals P1 and P2. The filter 100 may refer to a structure without the input/output terminals P1 and P2. The following description of Example Embodiment 1 is directed to a case where the filter 100 includes a dielectric substrate (multilayer body) including a plurality of stacked dielectric layers. In FIG. 1, the direction of stacking of the dielectric layers in the dielectric substrate is defined as a Z-axis direction, the direction of the long side of the filter 100 is defined as a Y-axis direction, and the direction of the short side of the filter 100 is defined as an X-axis direction. The x-axis, the Y-axis, and the Z-axis are orthogonal to each other.

The filter 100 has, for example, a cuboid shape. The filter 100 includes surfaces perpendicular or substantially perpendicular to the direction of stacking, of which the surface at the lower side in FIG. 1 is referred to as a bottom surface V and the surface at the upper side in FIG. 1 is referred to as a top surface U. Surfaces of the filter 100 that are parallel or substantially parallel to the direction of stacking are referred to as lateral surfaces.

The filter 100 includes, at the bottom surface V, an electrode (not illustrated) that electrically connects to the input/output terminals P1 and P2 and to a shielding conductor 30. The filter 100 is mounted to a substrate by the electrode provided at the bottom surface V. For example, the electrode at the bottom surface V of the filter 100 is a land grid array (LGA) terminal including a plurality of land electrodes that are arranged regularly. The input/output terminals P1 and P2, and the shielding conductor 30 may be provided at lateral surfaces of the filter 100. A direction identification mark DM is provided on the top surface U of the filter 100. When mounting the filter 100, the top surface U and the bottom surface V can be identified based on the direction identification mark DM. However, in a case where the filter 100 is provided with an LGA terminal, the surface provided with the LGA terminal may be defined as the bottom surface V, even in the absence of such a direction identification mark DM.

As illustrated in FIG. 1, in the filter the resonator 10 is disposed between a shielding conductor 20 positioned on or adjacent to the top surface U, and the shielding conductor 30 positioned on or adjacent to the bottom surface V.

The shielding conductor 20 is electrically connected to the shielding conductor 30 by a plurality of via electrodes 41 to 48. The shielding conductor 30 is electrically connected to the electrode (not illustrated) provided at the bottom surface V. Since the electrode is connected to GND as a ground electrode, the shielding conductor 30 is at the same or substantially the same potential as GND. The shielding conductor 20, which is electrically connected to the shielding conductor 30 via the via electrodes 41 to 48, is also at the same or substantially the same potential as GND. The via electrodes 41 to 48 also define and function as shielding conductors for the lateral surfaces of the filter 100. Accordingly, the filter 100 may be provided with plate-shaped shielding conductors instead of the via electrodes 41 to 48. An electrically connected via electrode (not illustrated) is provided for each of the input/output terminals P1 and P2.

The resonator 10 includes a conductive pattern 5 (a first planar electrode), which is located at a higher layer than the shielding conductor 30 and elongated in the X-axis direction, and a conductive pattern 6 (a third planar electrode), which is spaced apart from the conductive pattern 5 in the Y-axis direction. The conductive pattern 6 has a rectangular or substantially rectangular shape the same or substantially the same as that of the conductive pattern 5 and elongated in the X-axis direction. In the filter 100, the shielding conductor 30 on or adjacent to the bottom surface V corresponds to a first shielding conductor, and the shielding conductor 20 on or adjacent to the top surface U corresponds to a second shielding conductor.

The conductive pattern 5 is electrically connected with one end of a via electrode 1 (a first via electrode) and one end of a via electrode 3 (a third via electrode). The via electrode 1 and the via electrode 3 are arranged side by side on the conductive pattern 5 and spaced apart from each other in the X-axis direction. Similarly, the conductive pattern 6 is electrically connected with one end of a via electrode 2 (a second via electrode) and one end of a via electrode 4 (a fourth via electrode). The via electrode 2 and the via electrode 4 are arranged side by side on the conductive pattern 6 and spaced apart from each other in the X-axis direction.

The filter 100 is provided with two via electrodes (the via electrodes 1 and 3, the via electrodes 2 and 4) in the X-axis direction. However, the filter 100 may be provided with only one via electrode (the via electrode 1, the via electrode 2) in the X-axis direction. The presence of two via electrodes (the via electrodes 1 and 3, the via electrodes 2 and 4) in the X-axis direction provide an improved Q-factor of the filter 100 compared with a case where only one via electrode (the via electrode 1, the via electrode 2) is present. It is also possible to provide three or more via electrodes in the X-axis direction. In this case, the Q-factor of the filter 100 can be further improved.

Each of the via electrodes 1 to 4 is electrically connected at the other end to a common electrode 7. The common electrode 7 is defined by a single rectangular conductive pattern (conductor) electrically connected to the other end of each of the via electrodes 1 to 4. Alternatively, however, the common electrode 7 may include the following separate conductive patterns: a conductive pattern (a second planar electrode) electrically connected to the other end of the via electrode 1 and the other end of the via electrode 3; a conductive pattern (a fourth planar electrode) electrically connected to the other end of the via electrode 2 and the other end of the via electrode 4; and a conductive pattern connecting the two conductive patterns mentioned above. The conductive patterns (the second planar electrode and the fourth planar electrode) are rectangular or substantially rectangular conductive patterns that are elongated in the X-axis direction.

In the filter 100, the via electrodes 1 and 3 are electrically connected to the via electrodes 2 and 4 by the common electrode 7. This configuration makes it possible to reduce changes in resonant frequency that may result from changes in diameter of each of the via electrodes 1 to 4. FIG. 2 is a graph illustrating the insertion loss of the filter 100 according to Example Embodiment 1. In FIG. 2, the horizontal axis represents frequency, and the vertical axis represents insertion loss. Graph A represents the insertion loss with the diameter of each of the via electrodes 1 to 4 set to a design value (e.g., about 100 μm). Graph B represents the insertion loss with the diameter increased by about 10 μm (about +10 μm) relative to the design value. Graph C represents the insertion loss with the diameter decreased by about 10 μm (about-10 μm) relative to the design value.

As illustrated in FIG. 2, the filter 100 has two resonant frequencies, one being the resonant frequency in transverse electromagnetic (TEM) mode at approximately 31.3 GHZ, and the other being the resonant frequency in transverse electric (TE) mode at approximately 35.6 GHZ. Of the two resonant frequencies, the resonant frequency at approximately 31.3 GHZ changes only by about 0.1% even when the diameter of the via electrodes 1 to 4 changes by about +10 μm.

The common electrode 7 extends outward by a large area beyond the positions where the common electrode 7 is connected to the via electrodes 1 to 4. This configuration makes it possible to increase the capacitance generated between the common electrode 7 and the shielding conductor 20, and consequently adjust the resonant frequency in transverse electric (TE) mode to a lower frequency range. The conductive patterns 5 and 6 are configured to extend outward by a large area beyond the positions where the conductive patterns 5 and 6 are connected to the via electrodes 1 to 4. This configuration makes it possible to increase the capacitance generated between the shielding conductor 30 and each of the conductive patterns 5 and 6, and consequently adjust the resonant frequency in transverse electromagnetic (TEM) mode to a lower frequency range.

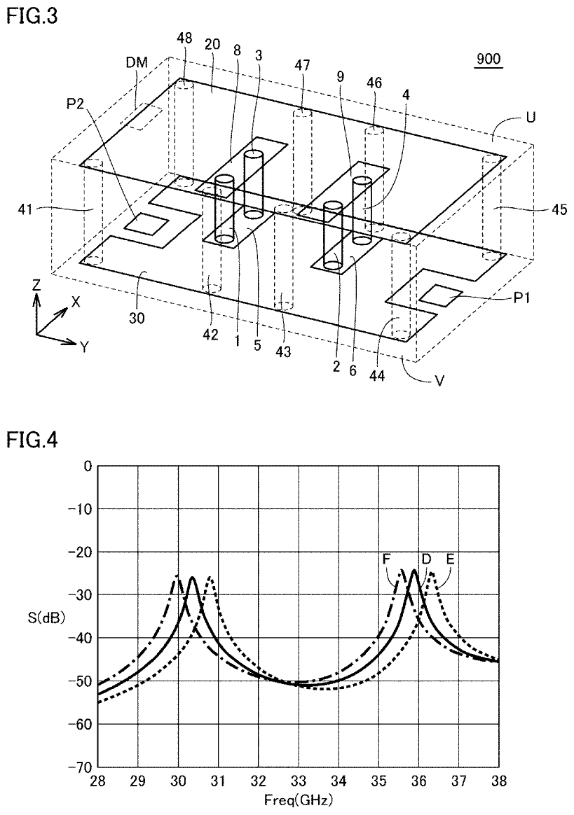

As a filter according to a comparative example, a filter with no common electrode is described below. FIG. 3 schematically illustrates a filter 900 according to a comparative example. Structural features of the filter 900 in FIG. 3 that are the same or substantially the same as those of the filter 100 in FIG. 1 are designated by the same reference signs and not described in further detail.

As illustrated in FIG. 3, the filter 900 is provided with a conductive pattern 8, and a conductive pattern 9. The conductive pattern 8 is electrically connected to the other end of the via electrodes 1 and the other end of the via electrode 3. The conductive pattern 9 is electrically connected to the other end of the via electrode 2 and the other end of the via electrode 4. The conductive pattern 8 is not electrically connected to the conductive pattern 9, and the via electrode 1 and the via electrode 3 are electrically independent from the via electrode 2 and the via electrode 4.

Due to the above-described configuration, changes in diameter of each of the via electrodes 1 to 4 cause the resonant frequency of the filter 900 to also change significantly. FIG. 4 is a graph illustrating the insertion loss of the filter 900. In FIG. 4, the horizontal axis represents frequency, and the vertical axis represents insertion loss. Graph D represents the insertion loss with the diameter of each of the via electrodes 1 to 4 set to a design value (e.g., about 100 μm). Graph E represents the insertion loss with the diameter increased by about 10 μm (about +10 μm) relative to the design value. Graph F represents the insertion loss with the diameter decreased by about 10 μm (about −10 μm) relative to the design value.

As illustrated in FIG. 4, the filter 900 has two resonant frequencies, one at approximately 30.4 GHZ and the other at approximately 35.9 GHZ. Of the two resonant frequencies, the resonant frequency at approximately 30.4 GHZ changes by about 1.3% when the diameter of the via electrodes 1 to 4 changes by about +10 μm, and the resonant frequency at approximately 35.9 GHZ changes by about 1.0% when the diameter of the via electrodes 1 to 4 changes by about +10 μm.

It is thus appreciated that electrically connecting the via electrode 1 and the via electrode 3 to the via electrode 2 and the via electrode 4 by the common electrode 7 as described above makes it possible to reduce changes in resonant frequency of the filter 100 that may result from changes in diameter of the via electrodes 1 to 4. The following description explains, in detail, why it is possible for the filter 100 to reduce changes in resonant frequency that may result from changes in diameter of the via electrodes 1 to 4.

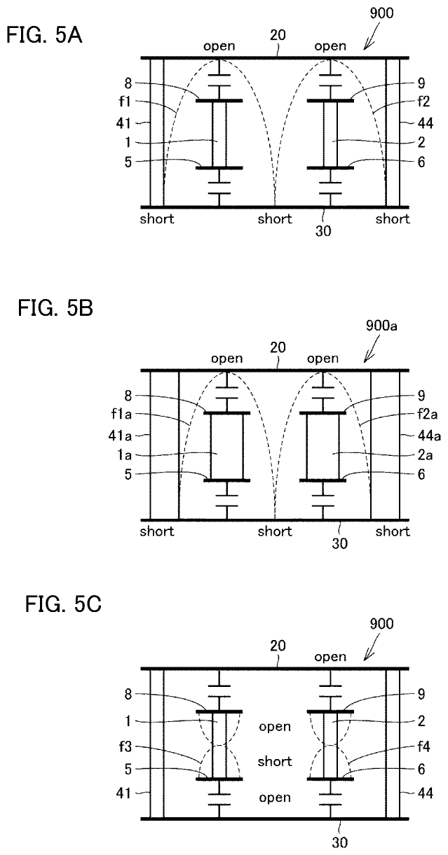

First, FIGS. 5A to 5C illustrate transverse electric (TE) mode resonance and transverse electromagnetic (TEM) mode resonance in the filter 900. FIG. 5A schematically illustrates transverse electric (TE) mode resonance in the filter 900. In transverse electric (TE) mode, the via electrode 1 and the via electrode 2 define and function as two floating via electrodes each capacitively coupled to the shielding conductor 20 and the shielding conductor 30. As illustrated in FIG. 5A, a half-wavelength resonance f1 occurs in the via electrode 1, with both ends being short-circuited. Further, as illustrated in FIG. 5A, a half-wavelength resonance f2 occurs in the via electrode 2, with both ends being short-circuited. Although not illustrated, the resonance f1 occurs in the via electrode 3, and the resonance f2 occurs in the via electrode 4.

In transverse electric (TE) mode, the frequencies of the resonances f1 and f2 are determined by the outer volume of the filter 900 (dielectric substrate), and thus the frequencies of the resonances f1 and f2 change with changes in diameter of the via electrodes 1 and 2. FIG. 5B schematically illustrates transverse electric (TE) mode resonance in a filter 900a with a via electrode 1a and a via electrode 2b that have an increased diameter. In the filter 900a, the via electrode 1a and the via electrode 2b have an increased diameter, and via electrodes 41a and 44a also have an increased diameter.

In the filter 900a, the via electrode 1a and the via electrode 2b have an increased diameter, which causes resonances f1a and f2a occurring in the via electrodes 1a and 2a to become smaller than the resonances f1 and f2 occurring in the via electrodes 1 and 2. As a result, the resonant frequency in transverse electric (TE) mode becomes higher.

FIG. 5C schematically illustrates transverse electromagnetic (TEM) mode resonance in the filter 900. In transverse electromagnetic (TEM) mode, the via electrode 1 and the via electrode 2 define and function as floating via electrodes each capacitively coupled to the shielding conductor 20 and the shielding conductor 30. As illustrated in FIG. 5C, a half-wavelength resonance f3 occurs in the via electrode 1, with both ends being open. Further, as illustrated in FIG. 5C, a half-wavelength resonance f4 occurs in the via electrode 2, with both ends being open. Although not illustrated, the resonance f3 occurs in the via electrode 3, and the resonance f4 occurs in the via electrode 4.

In transverse electromagnetic (TEM) mode, the frequencies of the resonances f3 and f4 are determined by the lengths of the via electrodes 1 and 2, and thus the frequencies of the resonances f3 and f4 do not change with changes in diameter of the via electrodes 1 and 2, respectively. However, since the resonant frequency in transverse electromagnetic (TEM) mode is determined by the lengths of the via electrodes 1 and 2, and the resonant frequency in transverse electromagnetic (TEM) mode is higher than the resonant frequency in transverse electric (TE) mode.

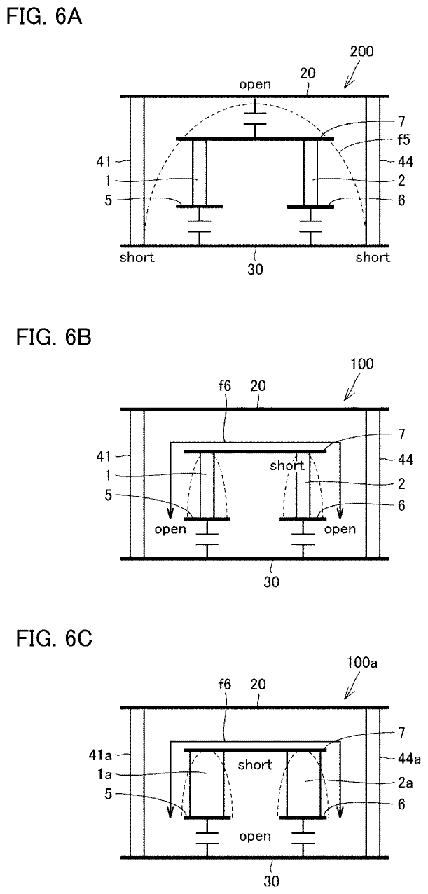

Accordingly, in the filter 100, the via electrode 1 and the via electrode 2 are electrically connected by the common electrode 7, so that the two floating via electrodes define and function as a single floating via electrode with an increased length. The resonant frequency in transverse electromagnetic (TEM) mode is thus lowered. FIGS. 6A to 6C illustrate transverse electric (TE) mode resonance and transverse electromagnetic (TEM) mode resonance in the filter according to Example Embodiment 1.

FIG. 6A schematically illustrates transverse electric (TE) mode resonance in the filter 100. In transverse electric (TE) mode, due to the common electrode 7, the via electrode 1 and the via electrode 2 define and function integrally as a single floating via electrode, and each capacitively couple to the shielding conductor 20 and the shielding conductor 30. As illustrated in FIG. 6A, a half-wavelength resonance f5 occurs in the via electrodes 1 and 2, with both ends being short-circuited. Although not illustrated, the resonance f5 occurs also in the via electrodes 3 and 4.

FIG. 6B schematically illustrates transverse electromagnetic (TEM) mode resonance in the filter 100. In transverse electromagnetic (TEM) mode, the via electrodes 1 and 2 are electrically connected at one side by the common electrode 7, and the one side is not capacitively coupled to the shielding conductor 20, whereas the other side defines and functions as a floating via electrode capacitively coupled to the shielding conductor 30. As illustrated in FIG. 6B, a half-wavelength resonance f6 occurs in the via electrodes 1 and 2, with the other end of the via electrode 1 and the other end of the via electrode 2 being open. Although not illustrated, the resonance f6 occurs also in the via electrodes 3 and 4.

The frequency of the resonance f6 in transverse electromagnetic (TEM) mode of the filter 100 is determined by the sum of the length of the via electrode 1 and the length of the via electrode 2. Accordingly, in a filter 100a in FIG. 6C, even when the via electrode 1a and the via electrode 2b are increased in diameter, the resonance f6 in transverse electromagnetic (TEM) mode occurs in the same or substantially the same manner as with the filter 100. That is, the resonance f6 in transverse electromagnetic (TEM) mode of the filter 100 does not change even when the via electrodes 1 and 2 are increased in diameter.

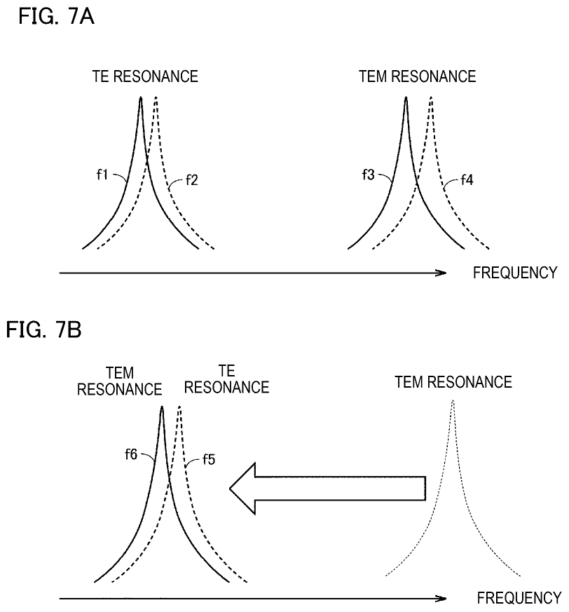

FIGS. 7A and 7B illustrate the relationships between the resonant frequency in transverse electric (TE) mode and the resonant frequency in transverse electromagnetic (TEM) mode. With the filter 900, the frequency of the resonance f3 or f4 in transverse electromagnetic (TEM) mode is determined by the length of the via electrode 1 or 2, and thus higher than the frequency of the resonance f1 or f2 in transverse electric (TE) mode as illustrated in FIG. 7A. With the filter 100, the frequency of the resonance f6 in transverse electromagnetic (TEM) mode is determined by the sum of the length of the via electrode 1 and the length of the via electrode 2, and thus shifts closer to the frequency of the resonance f5 in transverse electric (TE) mode as illustrated in FIG. 7B. That is, with the filter 100, the resonant frequency in transverse electromagnetic (TEM) mode is shifted to the vicinity of the resonant frequency in transverse electric (TE) mode, so that the two resonant modes occur within the same frequency band. Accordingly, in the filter 100, the resonant frequency in transverse electromagnetic (TEM) mode, which changes relatively little with changes in diameter of the via electrodes 1 to 4, is used as an attenuation pole. This configuration makes it possible to reduce frequency variations of the attenuation pole that result from manufacturing variations.

### Modification 1

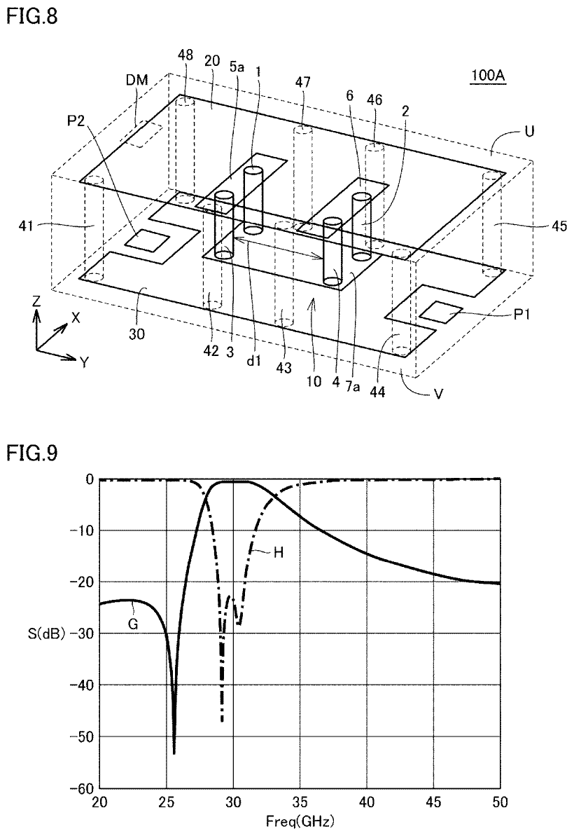

The filter 100 is provided with the common electrode 7 on or adjacent to the top surface U to shift the resonant frequency in transverse electromagnetic (TEM) mode. However, shifting the resonant frequency in transverse electromagnetic (TEM) mode may be accomplished simply by electrically connecting the via electrodes 1 and 2 at one end portion or the other end portion thereof. Accordingly, a filter according to Modification 1 of an example embodiment of the present invention will now be described in which a common electrode is provided at or adjacent to the bottom surface. FIG. 8 schematically illustrates a filter 100A according to Modification 1. Structural features of the filter 100A in FIG. 8 that are the same or substantially the same as those of the filter 100 in FIG. 1 are designated by the same reference signs and not described in further detail.

In the filter 100A, a common electrode 7a is located at a higher layer than the shielding conductor 30. The common electrode 7a is electrically connected with the other end of each of the via electrodes 1 to 4. The common electrode 7a is defined by a single rectangular conductive pattern electrically connected to the other end of each of the via electrodes 1 to 4. Alternatively, however, the common electrode 7a may include the following conductive patterns: a conductive pattern (the second planar electrode) electrically connected to the other end of the via electrode 1 and the other end of the via electrode 3, a conductive pattern (the fourth planar electrode) electrically connected to the other end of the via electrode 2 and the other end of the via electrode 4, and a conductive pattern connecting the two conductive patterns described above.

The resonator 10 includes a conductive pattern 5a (the first planar electrode), which is located at a lower layer than the shielding conductor 20 and elongated in the X-axis direction, and a conductive pattern 6a (the third planar electrode), which is spaced apart from the conductive pattern 5a in the Y-axis direction. The conductive pattern 6a has a rectangular or substantially rectangular shape the same or substantially the same as that of the conductive pattern 5a and elongated in the X-axis direction. The conductive pattern 5a is electrically connected with one end of the via electrode 1 and one end of the via electrode 3. The conductive pattern 6a is electrically connected with one end of the via electrode 2 and one end of the via electrode 4. In the filter 100A, the shielding conductor 20 on or adjacent to the top surface U corresponds to the first shielding conductor, and the shielding conductor 30 on or adjacent to the bottom surface V corresponds to the second shielding conductor.

FIG. 9 is a graph illustrating the insertion loss and return loss of the filter 100A according to Modification 1. In FIG. 9, the horizontal axis represents frequency, and the vertical axis represents insertion loss or return loss. Graph G represents the insertion loss of the filter 100A. Graph H represents the return loss of the filter 100A. As illustrated in FIG. 9, the filter 100A has a resonant frequency at approximately 26.0 GHZ for insertion loss, and has a resonant frequency at approximately 29.0 GHz for return loss. The filter 100A thus has an attenuation pole located in a lower frequency range.

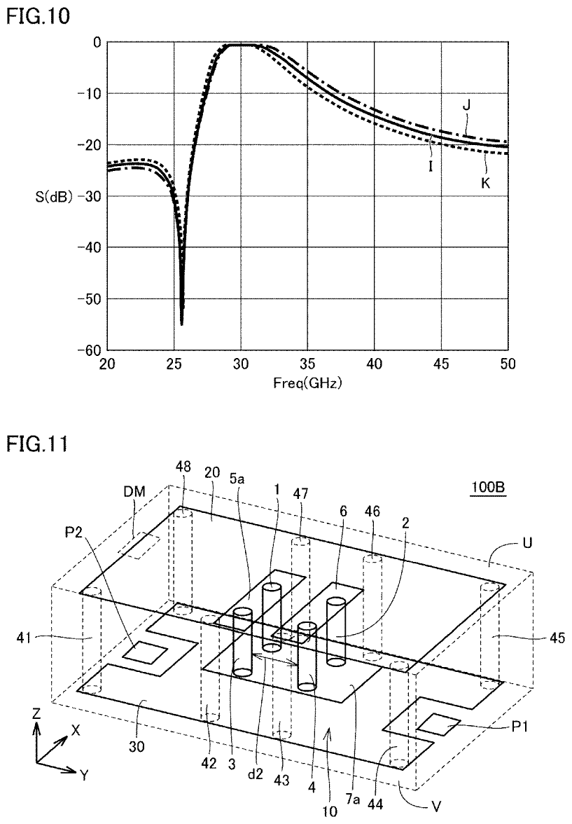

FIG. 10 is a graph illustrating the insertion loss of the filter according to Modification 1, with varying via electrode diameter. In FIG. 10, the horizontal axis represents frequency, and the vertical axis represents insertion loss. Graph I represents the insertion loss with the diameter of each of the via electrodes 1 to 4 set to a design value (e.g., about 100 μm). Graph J represents the insertion loss with the diameter increased by about 10 μm (about +10 μm) relative to the design value. Graph K represents the insertion loss with the diameter decreased by about 10 μm (about-10 μm) relative to the design value.

As illustrated in FIG. 10, the filter 100A has a resonant frequency at approximately 26.0 GHZ. The resonant frequency at approximately 26.0 GHz hardly changes even when the via electrodes 1 to 4 change in diameter by about +10 μm.

In the filter 100A, the common electrode 7a (the second planar electrode and the fourth planar electrode) is positioned on or adjacent to the bottom surface of the filter 100A. As a result, the shielding conductor 20 capacitively couples to the conductive patterns 5a and 6a. The shielding conductor 20 is electrically connected to the shielding conductor 30 by the via electrodes 41 to 48, and connected to GND. The filter 100A is thus more susceptible to the influence of the parasitic inductances of the via electrodes 41 to 48 than is the filter 100. In the filter 100A, such parasitic inductances are utilized to adjust the position of the attenuation pole.

### Modification 2

In the filter 100, the distance between the via electrode 1 and the via electrode 2 is greater than the distance between the via electrode 1 and the via electrode 3. Changing the distance between the via electrode 1 and the via electrode 2 makes it possible to change the resonant frequency for insertion loss. FIG. 11 schematically illustrates a filter 100B according to Modification 2 of an example embodiment of the present invention. Structural features of the filter 100B in FIG. 11 that are the same or substantially the same as those of the filter 100 in FIG. 1 and those of the filter 100A in FIG. 8 are designated by the same reference signs and not described in further detail.

In the filter 100B, the distance d2 between the via electrode 1 and the via electrode 2 is shorter than the distance d1 between the via electrode 1 and the via electrode 2 in the filter 100A illustrated in FIG. 8. A shorter distance between the via electrode 1 and the via electrode 2 results in stronger magnetic coupling between the via electrode 1 and the via electrode 2, which in turn results in higher resonant frequency for insertion loss. This allows the attenuation pole to shift to a higher frequency range. In contrast, a longer distance between the via electrode 1 and the via electrode 2 results in weaker magnetic coupling between the via electrode 1 and the via electrode 2, which in turn results in lower resonant frequency for insertion loss. This allows the attenuation pole to shift to a lower frequency range. The distance d2 between the via electrode 1 and the via electrode 2 may be either longer or shorter than the distance between the via electrode 1 and the via electrode 3 (or the distance between the via electrode 2 and the via electrode 4).

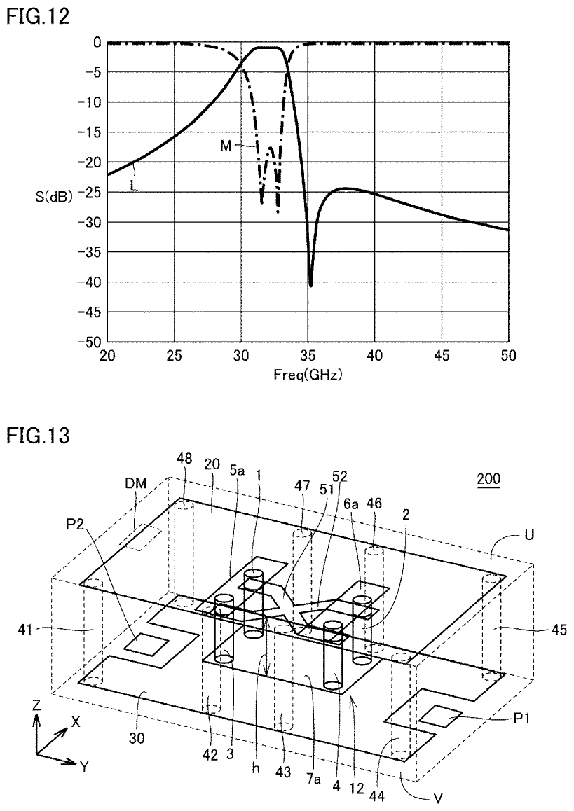

FIG. 12 is a graph illustrating the insertion loss and return loss of the filter 100B according to Modification 2. In FIG. 12, the horizontal axis represents frequency, and the vertical axis represents insertion loss or return loss. Graph L represents the insertion loss of the filter 100B. Graph M represents the return loss of the filter 100B. As illustrated in FIG. 12, the filter 100B has a resonant frequency at approximately 35.5 GHZ for insertion loss, and has a resonant frequency at approximately 32.0 GHz for return loss. The filter 100B thus has an attenuation pole located in a higher frequency range. That is, the distance d2 between the via electrode 1 and the via electrode 2 is shortened to increase the resonant frequency for insertion loss.

### Example Embodiment 2

As described above with reference to Modification 2 of Example Embodiment 1, in the filter 100B, the position of the attenuation pole is adjusted by changing the distance between the via electrode 1 and the via electrode 2. Example Embodiment 2 of the present invention described below is directed to a configuration in which two via electrodes are electrically connected by a wiring line different from a common electrode to thus adjust the position of the attenuation pole. FIG. 13 schematically illustrates a filter 200 according to Example Embodiment 2. Structural features of the filter 200 in FIG. 13 that are the same or substantially the same as those of the filter 100 in FIG. 1 and those of the filter 100A in FIG. 8 are designated by the same reference signs and not described in further detail.

The filter 100B includes a resonator 12, and the input/output terminals P1 and P2. As illustrated in FIG. 13, the resonator 12 includes a wiring pattern 51 (a first wiring pattern), and a wiring pattern 52 (a second wiring pattern). The wiring pattern 51 electrically connects the via electrode 1 and the via electrode 4. The wiring pattern 52 electrically connects the via electrode 2 and the via electrode 3. By electrically connecting the via electrodes 1 and 3 to the via electrodes 2 and 4 by wiring lines other than the common electrode 7a, the strength of magnetic coupling of the via electrodes 1 and 3 with the via electrodes 2 and 4 can be increased. The filter 100B is thus configured to enable the position of the attenuation pole to be adjusted by the wiring patterns 51 and 52, without changing the distance of the via electrodes 1 and 3 to the via electrodes 2 and 4.

Specifically, an increase in area (wiring width x wiring length) of the wiring patterns 51 and 52 produces stronger magnetic coupling of the via electrodes 1 and 3 with the via electrodes 2 and 4, and consequently higher resonant frequency for insertion loss. This enables the attenuation pole to shift to a higher frequency range. In contrast, a decrease in area of the wiring patterns 51 and 52 produces weaker magnetic coupling of the via electrodes 1 and 3 with the via electrodes 2 and 4, and consequently lower resonant frequency for insertion loss. This enables the attenuation pole to shift to a lower frequency range.

With the filter 100B, the position of the attenuation pole can be adjusted also by the distance h from the common electrode 7a to the wiring patterns 51 and 52. Specifically, increasing the distance h from the common electrode 7a to the wiring patterns 51 and 52 produces stronger magnetic coupling of the via electrodes 1 and 3 with the via electrodes 2 and 4, and consequently higher resonant frequency for insertion loss. This enables the attenuation pole to shift to a higher frequency range. In contrast, decreasing the distance h from the common electrode 7a to the wiring patterns 51 and 52 produces weaker magnetic coupling of the via electrodes 1 and 3 with the via electrodes 2 and 4, and consequently lower resonant frequency for insertion loss. This enables the attenuation pole to shift to a lower frequency range.

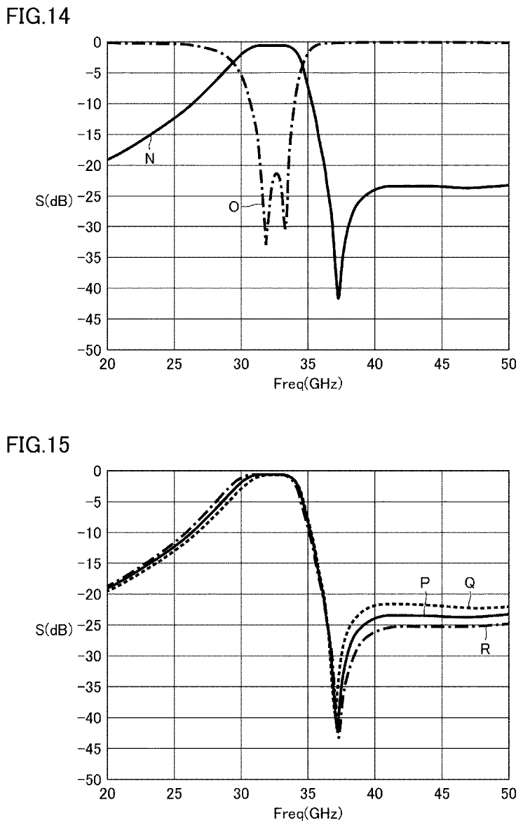

FIG. 14 is a graph illustrating the insertion loss and return loss of the filter 200 according to Example Embodiment 2. In FIG. 14, the horizontal axis represents frequency, and the vertical axis represents insertion loss or return loss. Graph N represents the insertion loss of the filter 200. Graph O represents the return loss of the filter 200. As illustrated in FIG. 14, the filter 200 has a resonant frequency at approximately 37.5 GHZ for insertion loss, and has a resonant frequency at approximately 32.0 GHz for return loss. The filter 200 thus has an attenuation pole located in a higher frequency range.

FIG. 15 is a graph illustrating the insertion loss of the filter 200 according to Example Embodiment 2, with varying via electrode diameter. In FIG. 15, the horizontal axis represents frequency, and the vertical axis represents insertion loss. Graph P represents the insertion loss with the diameter of each of the via electrodes 1 to 4 set to a design value (e.g., about 100 μm). Graph Q represents the insertion loss with the diameter increased by about 10 μm (about +10 μm) relative to the design value. Graph R represents the insertion loss with the diameter decreased by about 10 μm (about-10 μm) relative to the design value.

As illustrated in FIG. 15, the filter 200 has a resonant frequency at approximately 37.5 GHZ. The resonant frequency at approximately 37.5 GHZ hardly changes even when the via electrodes 1 to 4 change in diameter by about +10 μm.

As illustrated in FIG. 13, in the filter 100B, the via electrode 1 and the via electrode 4 are electrically connected by the wiring pattern 51, and the via electrode 2 and the via electrode 3 are electrically connected by the wiring pattern 52. However, the configuration of the filter 100B is not limited thereto. Alternatively, the via electrode 1 and the via electrode 2 may be electrically connected by a wiring pattern, and the via electrode 3 and the via electrode 4 may be electrically connected by a wiring pattern.

### Example Embodiment 3

The foregoing description of the example embodiments is directed to a filter with an attenuation pole located in a lower frequency range, and a filter with an attenuation pole located in a higher frequency range. The following description of Example Embodiment 3 of the present invention is directed to a band pass filter including a combination of filters, one with an attenuation pole located in a lower frequency range and another one with an attenuation pole located in a higher frequency range.

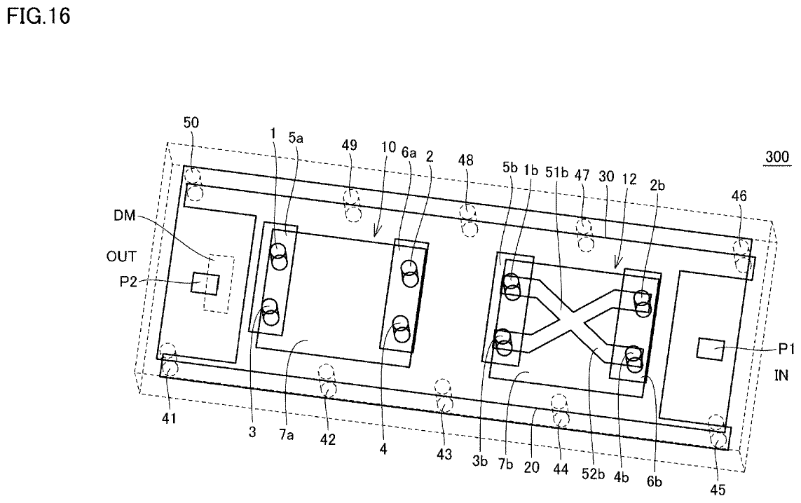

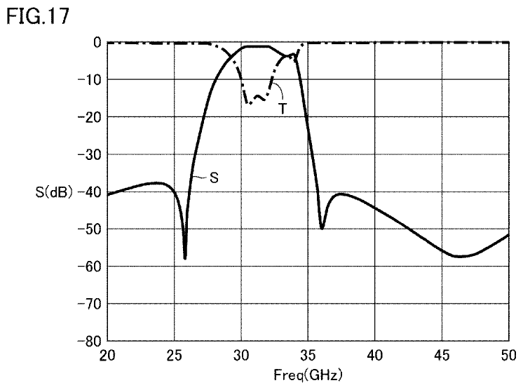

FIG. 16 schematically illustrates a filter 300 according to Example Embodiment 3. Structural features of the filter 300 in FIG. 16 that are the same or substantially the same as those of the filter 100 in FIG. 1, those of the filter 100A in FIG. 8, and those of the filter 200 in FIG. 13 are designated by the same reference signs and not described in further detail.

The filter 300 is a band pass filter including the input/output terminal P1 at the input side and the input/output terminal P2 at the output side. In the filter 300, the resonator 12 (a second resonator) of the filter 200, and the resonator 10 (a first resonator) of the filter 100A are arranged in this order in the Y-axis direction. In FIG. 16, to avoid duplication of reference signs between the resonator 10 of the filter 100A and the resonator 12 of the filter 200, a suffix “b” is added to the reference signs representing the same structural features as those of the filter 200 illustrated in FIG. 13.

Specifically, the filter 200 includes the following components: a conductive pattern 5b (a fifth planar electrode) that is disposed in a dielectric substrate, and connected to one end of a via electrode 1b (a fifth via electrode) and one end of a via electrode 3b; a common electrode 7b (a sixth planar electrode) that is disposed in the dielectric substrate, and connected to the other end of the via electrode 1b and the other end of the via electrode 3b, a conductive pattern 6b (a seventh planar electrode) that is disposed in the dielectric substrate, and connected to one end of a via electrode 2b (a sixth via electrode) and one end of a via electrode 4b (an eighth via electrode); and the common electrode 7b (an eighth planar electrode) that is disposed in the dielectric substrate, and connected to the other end of the via electrode 2b and the other end of the via electrode 4b. The conductive pattern 5b and the conductive pattern 6b are each capacitively coupled to the shielding conductor 20 (the first shielding conductor) individually. The filter 200 further includes a wiring pattern 51b (a third wiring pattern), and a wiring pattern 52b (a fourth wiring pattern). The wiring pattern 51b electrically connects the via electrode 1b and the via electrode 4b. The wiring pattern 52b electrically connects the via electrode 2b and the via electrode 3b.

The shielding conductor 20 is electrically connected to the shielding conductor 30 by a plurality of via electrodes 41 to 50. The shielding conductor 30 is electrically connected to the electrode (not illustrated) provided at the bottom surface V. Since the electrode is connected to GND as a ground electrode, the shielding conductor 30 is at the same or substantially the same potential as GND. The shielding conductor 20, which is electrically connected to the shielding conductor 30 via the via electrodes 41 to 50, is also at the same or substantially the same potential as GND.

FIG. 17 is a graph illustrating the insertion loss and return loss of the filter 300 according to Example Embodiment 3. In FIG. 17, the horizontal axis represents frequency, and the vertical axis represents insertion loss or return loss. Graph S represents the insertion loss of the filter 300. Graph T represents the return loss of the filter 300. As illustrated in FIG. 17, the filter 300 has resonant frequencies at approximately 26.0 GHz and approximately 36.5 GHZ for insertion loss. The resonant frequency at approximately 26.0 GHz is the attenuation pole on the lower frequency side, and the resonant frequency at approximately 36.5 GHz is the attenuation pole on the higher frequency side. The filter 300 has a resonant frequency at approximately 31.0 GHZ for return loss. Accordingly, the filter 300 defines a band pass filter having the lower-frequency pole at approximately 26.0 and GHZ the higher-frequency pole at approximately 36.5 GHZ.

### OTHER MODIFICATIONS

In the filters 100, 100A, 100B, 200, 300 described above with reference to the above-described example embodiments, the distance between the via electrode 1 and the via electrode 3 is preferably equal or substantially equal to the distance between the via electrode 2 and the via electrode 4. Making the distance between the via electrode 1 and the via electrode 3 equal or substantially equal to the distance between the via electrode 2 and the via electrode 4 results in a bilaterally symmetrical structure, which makes the reflection characteristics at the input and output of the filter symmetrical and helps to reduce changes in characteristics caused by processing variations. In the filters 100, 100A, 100B, 200, the distance between the via electrode 1 and the via electrode 3 may be different from the distance between the via electrode 2 and the via electrode 4.

In the filters 100, 100A, 100B, 200, 300 described above with reference to the above-described example embodiments, the sum of the area of the conductive pattern 5, 5a (the first planar electrode) and the area of the conductive pattern 6, 6a (the third planar electrode) is preferably less than the area of the common electrode 7, 7a (the sum of the area of the second planar electrode and the area of the fourth planar electrode). Making the area of the common electrode 7, 7a greater than the sum of the area of the conductive pattern 5, 5a and the area of the conductive pattern 6, 6a enables the common electrode 7, 7a to be easily provided as a single rectangular or substantially rectangular conductive pattern. The area of the common electrode 7, 7a may be less than the sum of the area of the conductive pattern 5, 5a and the area of the conductive pattern 6, 6a. In this case, for example, the common electrode 7, 7a has an I-shape when viewed from the top side.

In the filters 100, 100A, 100B, 200, 300 described above with reference to the above-described example embodiments, for example, the pass band preferably ranges from about 10 GHz to about 200 GHz. The pass band of the filters 100, 100A, 100B, 200, 300 may be lower than about 10 GHZ, or may be higher than about 200 GHz.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A filter comprising:
a first via electrode and a second via electrode in a dielectric substrate;
a first shielding conductor on the dielectric substrate and located at or adjacent to one end of the first via electrode and one end of the second via electrode;
a second shielding conductor on the dielectric substrate and located at or adjacent to one other end of the first via electrode and one other end of the second via electrode;
a first planar electrode in the dielectric substrate and connected to the one end of the first via electrode;
a second planar electrode in the dielectric substrate and connected to the other end of the first via electrode;
a third planar electrode in the dielectric substrate and connected to the one end of the second via electrode; and
a fourth planar electrode in the dielectric substrate and connected to the other end of the second via electrode; wherein
the first planar electrode and the third planar electrode are each capacitively coupled to the first shielding conductor individually; and
the second planar electrode and the fourth planar electrode are electrically connected and define a common electrode.

2. The filter according to claim 1, wherein the second planar electrode and the fourth planar electrode defining the common electrode include a single conductor.

3. The filter according to claim 1, further comprising:
a third via electrode connected at one end to the first planar electrode, and connected at one other end to the second planar electrode; and
a fourth via electrode connected at one end to the third planar electrode, and connected at one other end to the fourth planar electrode.

4. The filter according to claim 3, wherein a distance between the first via electrode and the second via electrode is greater than a distance between the first via electrode and the third via electrode.

5. The filter according to claim 3, wherein a distance between the first via electrode and the third via electrode is equal or substantially equal to a distance between the second via electrode and the fourth via electrode.

6. The filter according to claim 3, wherein
a direction of stacking of dielectric layers in the dielectric substrate is defined as a Z-axis direction, a direction of a long side of the dielectric substrate is defined as a Y-axis direction, a direction of a short side of the dielectric substrate is defined as an X-axis direction;
the one end and the other end of each of the first via electrode, the second via electrode, the third via electrode, and the fourth via electrode are positioned in the Z-axis direction;
the second via electrode is positioned in the Y-axis direction with respect to the first via electrode;
the third via electrode is positioned in the X-axis direction with respect to the first via electrode; and
the fourth via electrode is positioned in the X-axis direction with respect to the second via electrode.

7. The filter according to claim 1, wherein
the filter includes a bottom surface to be mounted to a substrate; and
the second planar electrode and the fourth planar electrode defining the common electrode are positioned on or adjacent to the bottom surface of the filter.

8. The filter according to claim 3, further comprising:
a first wiring pattern electrically connecting the first via electrode and the fourth via electrode; and
a second wiring pattern electrically connecting the second via electrode and the third via electrode.

9. The filter according to claim 1, wherein a sum of an area of the first planar electrode and an area of the third planar electrode is less than a sum of an area of the second planar electrode and an area of the fourth planar electrode.

10. The filter according to a claim 3, further comprising:
a first resonator including the first via electrode, the second via electrode, the third via electrode, and the fourth via electrode; and
a second resonator including a fifth via electrode, a sixth via electrode, a seventh via electrode, and an eighth via electrode in the dielectric substrate; wherein
the second resonator includes:
a fifth planar electrode in the dielectric substrate and connected to one end of the fifth via electrode and one end of the seventh via electrode;
a sixth planar electrode in the dielectric substrate and connected to one other end of the fifth via electrode and one other end of the seventh via electrode;
a seventh planar electrode in the dielectric substrate and connected to one end of the sixth via electrode and one end of the eighth via electrode; and
an eighth planar electrode in the dielectric substrate and connected to one other end of the sixth via electrode and one other end of the eighth via electrode;
the fifth planar electrode and the seventh planar electrode are each capacitively coupled to the first shielding conductor individually;
the sixth planar electrode and the eighth planar electrode are electrically connected and define a common electrode;
the second resonator further comprises:
a third wiring pattern electrically connecting the fifth via electrode and the eighth via electrode; and
a fourth wiring pattern electrically connecting the sixth via electrode and the seventh via electrode; and
the second via electrode is positioned in a Y-axis direction with respect to the first via electrode.

11. The filter according to claim 10, wherein the sixth planar electrode and the eighth planar electrode defining the common electrode include a single conductor.

12. The filter according to claim 1, wherein the filter has a pass band from about 10 GHz to about 200 GHz.

13. The filter according to claim 1, wherein
the filter includes a top surface; and
a direction identification mark is provided on the top surface.

14. The filter according to claim 1, wherein the first and second shielding conductors are plate-shaped.

15. The filter according to claim 1, wherein each of the first and second via electrode has a diameter of about 100 μm.

16. The filter according to claim 1, wherein the common electrode has an I-shape.
